(19) United States
(12) Patent Application Publication
(10) Pub. No.: US 2005/0241130 A1
(43) Pub. Date: Nov. 3, 2005

(54) Apparatus for cleaning and processing two frameworks

(76) Inventors: Vinode Ramnauth, Ontario (CA); Leon Gimelshtein, Ontario (CA)

Correspondence Address: GIFFORD, KRASS, GROH, SPRINKLE & CITKOWSKI, P.C, PO BOX 7021, TROY, MI, 48007-7021, US

(21) Appl. No.: 10/833,730

(22) Filed: Apr. 28, 2004

(51) Int. Cl. B23P 23/00

(52) U.S. Cl. 29/56.5; 29/30

(57) ABSTRACT

An apparatus for cleaning welds on and machining rectangular plastic frames, such as sash frames, includes a supporting arrangement capable of rigidly supporting two plastic frames and holding them one above the other for cleaning and machining. Preferably, there are two tool mounting mechanisms each of which is equipped with two frame cleaning tools and at least one pair of machining tools. Each tool mounting mechanism is capable of moving its tools both horizontally and vertically and each is located adjacent a respective side of the supporting arrangement. The cleaning tools are mounted one above the other on each tool mounting mechanism as are the machining tools. The cleaning tools and the machining tools are capable of carrying out weld cleaning or machining on both plastic frames simultaneously.

### BACKGROUND OF THE INVENTION

This invention relates to apparatus and machines for processing rectangular plastic frames, such as window sashes or window frames, including, in particular, such apparatus capable of cleaning welds connecting frame sections together to form the rectangular frame.

It is well known in the plastic window frame and plastic window sash manufacturing industry to produce such frames in a horizontal four-head welding machine in which plastic frame sections for two window frames or two sashes can be positioned for simultaneous welding of the corner joints. Subsequent to welding the window frames or sashes, it is generally necessary to clean the four corners of the welded frames or sashes of excess material resulting from the welding process. This is commonly achieved with corner “cleaning” machines which can be automated.

A known difficulty with current manufacturing procedures which employ these four-head welding machines is that although the welding machine itself is capable of welding two or more window frames or sashes simultaneously, the corner cleaning machines are typically only capable of cleaning one window frame or sash at a time. Accordingly, it is desirable for a window frame manufacturer to have a corner cleaning machine that is capable of carrying out weld cleaning steps on two plastic frames that are mounted at the same time in the corner cleaning machine in order to expedite the time required to complete the manufacture of such plastic frames. In addition, it is also desirable if the corner cleaning machine can carry out additional machining or manufacturing steps on the two rectangular frameworks in addition to cleaning the welds at the four corners. It is preferable that such a machine for cleaning welds and carrying out additional manufacturing or machining steps on the frameworks operate at a speed that closely matches that achievable by the known welding machine, thus achieving maximum efficiencies and increasing the output of the production line.

In applicant's prior U.S. patent application Ser. No. 10/716,344 filed Nov. 18, 2003, there is described and illustrated an earlier form of corner cleaning machine into which two plastic frames from a welding machine can be fed at once using robot arm assemblies mounted on elevated horizontal tracks. The frameworks are fed into the corner cleaning machine and supported therein by two pairs of horizontally extending guide rails, with one pair of guide rails located above the second pair. One difficulty with this prior corner cleaning machine is that it uses the same cutting and finishing tools on each of the left and right sides of the machine to carry out the cutting and finishing operations on each of the two window frames or sashes. For example, since there is only one knife tool on each side of the machine, this same tool must be used to carry out the same or a similar weld cleaning operation at corresponding corners of the two plastic frames. As the speed of movement of each weld cleaning tool or each machining tool is to some extent limited, the need to use the same tool more than once to carry out similar cleaning or machining operations on the two frames tends to slow down the speed of operation of this known machine.

Accordingly, it is an object of one aspect of the invention to provide an improved apparatus which is capable of cleaning the welds on two plastic frames arranged one above the other in the apparatus at the same time, thereby speeding up the weld cleaning operation for two plastic frames.

It is a further object of another aspect of the invention to provide an improved apparatus that is capable of both cleaning welds on and machining rectangular plastic frames, such as window sashes, and that is capable of completing these steps on pairs of such frames by the use of at least one pair of cleaning tools and at least one pair of machining tools.

### SUMMARY OF THE INVENTION

According to one aspect of the invention, there is provided an apparatus for cleaning welds on rectangular plastic frames, such as window or sash frames, each formed from four frame sections comprising top and bottom frame sections and two parallel side frame sections. This apparatus includes first and second pairs of horizontally extending support rails with the rails of each pair being spaced horizontally apart a preselected distance corresponding to a dimension of a respective one of the rectangular frames that is arranged substantially horizontally and moved along that pair of rails during operation of the apparatus. The first pair of support rails is spaced above the second pair of support rails. There are also left and right supporting frame arrangements on which the pairs of support rails are mounted, one rail from each pair being mounted on the left supporting frame arrangement and one rail from each pair being mounted on the right supporting frame arrangement. Left and right tool mounting mechanisms, each capable of moving cleaning tools mounted thereon both horizontally and vertically, are also part of the apparatus. The left tool mounting mechanism is located adjacent the left supporting frame arrangement and the rails mounted thereon, and the right tool mounting mechanism is located adjacent the right supporting frame arrangement and the rails mounted thereon. A pair of frame cleaning tools are movably mounted on each of the tool mounting mechanisms with the frame cleaning tools of each pair being spaced apart and arranged one above the other a distance corresponding to a selected vertical distance between two plastic frames arranged respectively on the first and second pairs of support rails when the apparatus is carrying out a weld cleaning operation on the two plastic frames. Thus, each of the tool mounting mechanisms and its respective pair of cleaning tools is able to carry out a weld cleaning operation on both of the plastic frames simultaneously by each pair of cleaning tools being moved at the same time and in a similar manner by their respective tool mounting mechanism.

Preferably, an additional pair of machining tools is movably mounted on each of the tool mounting mechanisms. Each additional pair of tools is spaced-part and arranged one above the other the aforementioned distance corresponding to the distance between the two plastic frames.

According to another aspect of the invention, an apparatus for cleaning welds on and machining rectangular plastic frames, such as window sash frames, includes a supporting arrangement capable of rigidly supporting two of the plastic frames in a spaced apart manner and holding one plastic frame above the other in a manner that permits cleaning or machining operations to be carried out on the plastic frames simultaneously. The apparatus further includes at least one pair of spaced-apart frame cleaning tools and at least one pair of spaced-apart machining tools. There is also at least one tool mounting mechanism with the or each tool mounting mechanism having one pair of the cleaning tools and at least one pair of the machining tools mounted thereon. The tool mounting mechanism is capable of moving its respective cleaning tools and machining tools both horizontally and vertically. The at least one tool mounting mechanism is located adjacent the supporting arrangement. The cleaning tools of the one pair are mounted one above the other and the machining tools of the one or each pair are mounted one above the other. Each of the pair of cleaning tools and the at least one pair of machining tools is capable of carrying out a weld cleaning operation or a machining operation on both of the two plastic frames simultaneously by the appropriate pair of tools being moved at the same time and in a similar manner.

Preferably, there are two tool mounting mechanisms including a left tool mounting mechanism located adjacent a left side of the supporting arrangement and a right tool mounting mechanism located adjacent a right side of the supporting arrangement. Also, preferably the at least one pair of machining tools includes one pair of rotatable cutters and two motors for respectively rotating these cutters.

According to a further aspect of the invention, an apparatus for cleaning welds on and processing rectangular plastic frames, such as window sashes, includes a supporting arrangement capable of rigidly supporting two of the plastic frames in a spaced apart manner and holding one of the plastic frames above the other in a manner that permits weld cleaning or machining operations to be carried out on the two plastic frames simultaneously. The apparatus includes at least one pair of spaced apart weld cleaning devices adapted to carry out plastic weld cleaning operations, and at least one pair of spaced apart machining tools. There is also at least one tool mounting mechanism with the or each tool mounting mechanism having one pair of weld cleaning devices and at least one pair of the machining tools mounted thereon and capable of moving its respective weld cleaning devices and machine tools both horizontally and vertically. The at least one tool mounting mechanism is adapted for mounting adjacent the supporting arrangement. The weld cleaning devices of one pair are mounted one above the other and the machining tools of each pair are mounted one above the other and at different heights than the weld cleaning devices. The one pair of weld cleaning devices and the at least one pair of machining tools are capable of carrying out a weld cleaning operation or a machining operation on both of the plastic frames simultaneously by the appropriate pair of tools being moved at the same time and in a similar manner.

Further features and advantages of the preferred apparatus will be apparent from the following detailed description taken in conjunction with the accompanying drawings.

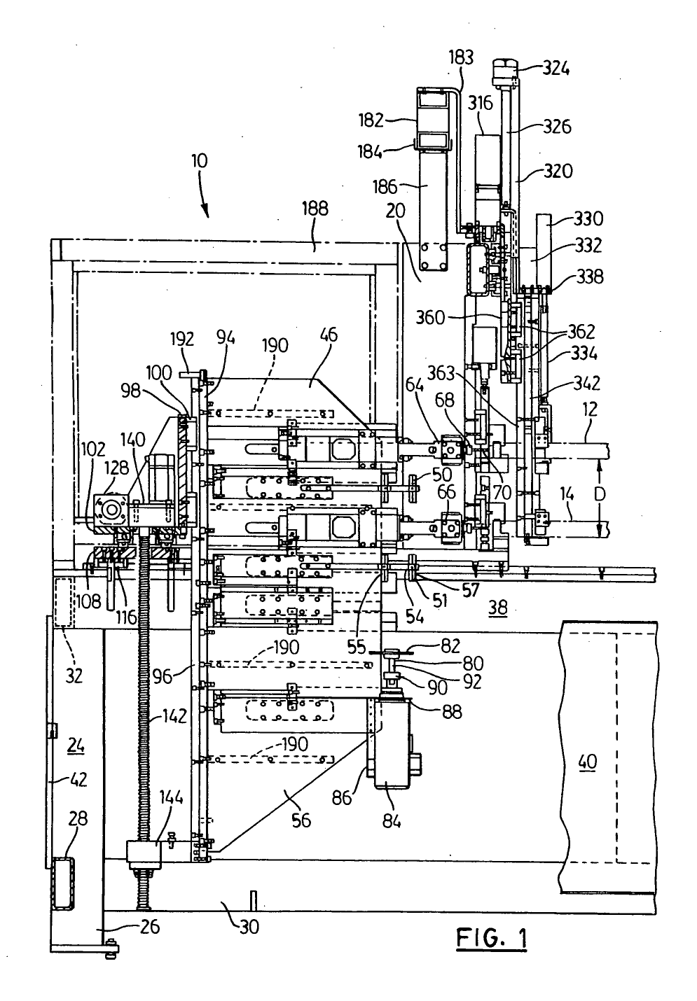

FIG. 1 is an end view of the left hand side of an apparatus for cleaning and processing frameworks constructed in accordance with the invention.

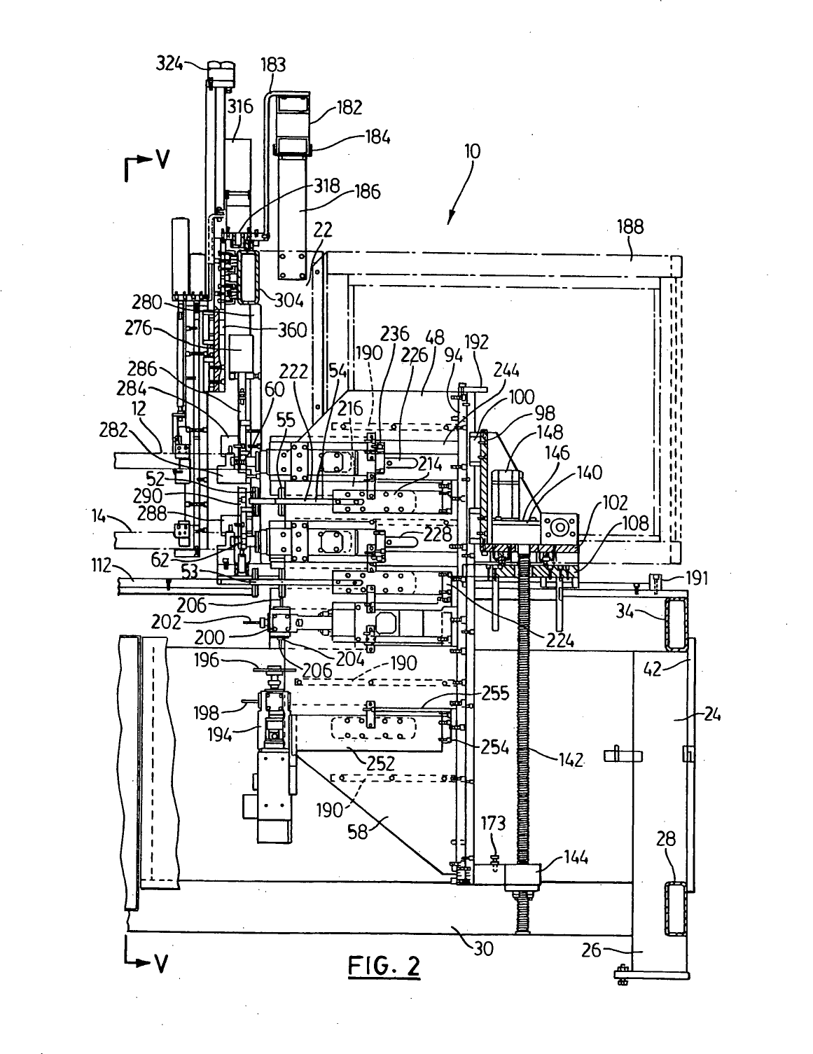

FIG. 2 is an end view similar to FIG. 1 but showing the righthand side of the apparatus;

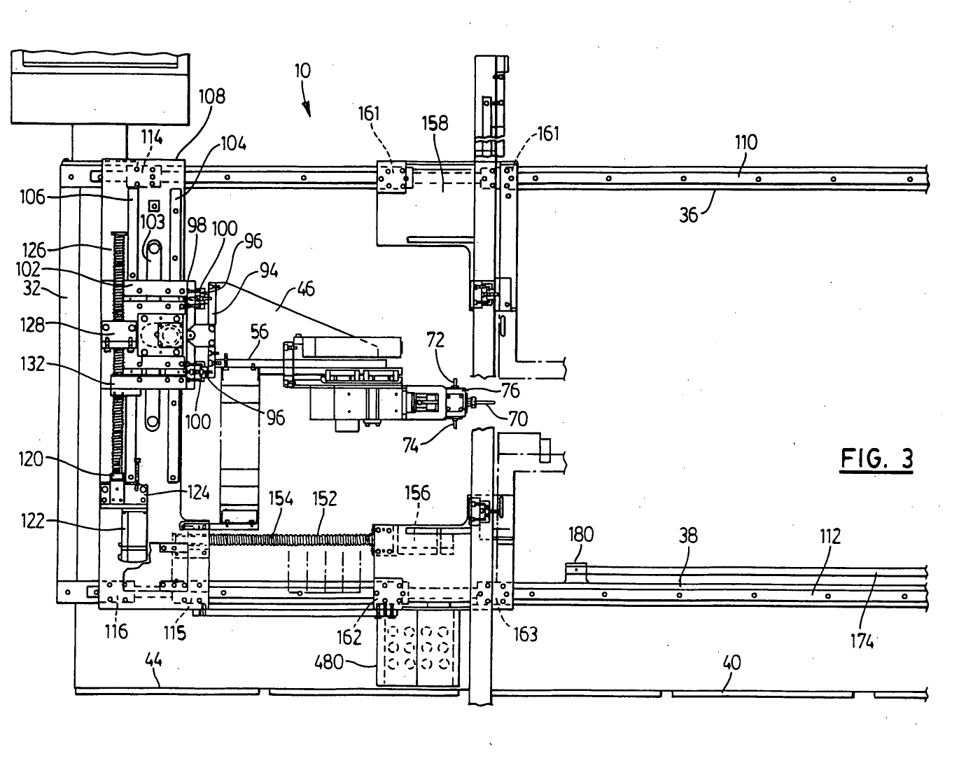

FIG. 3 is a top view of the left hand side of the apparatus of FIGS. 1 and 2;

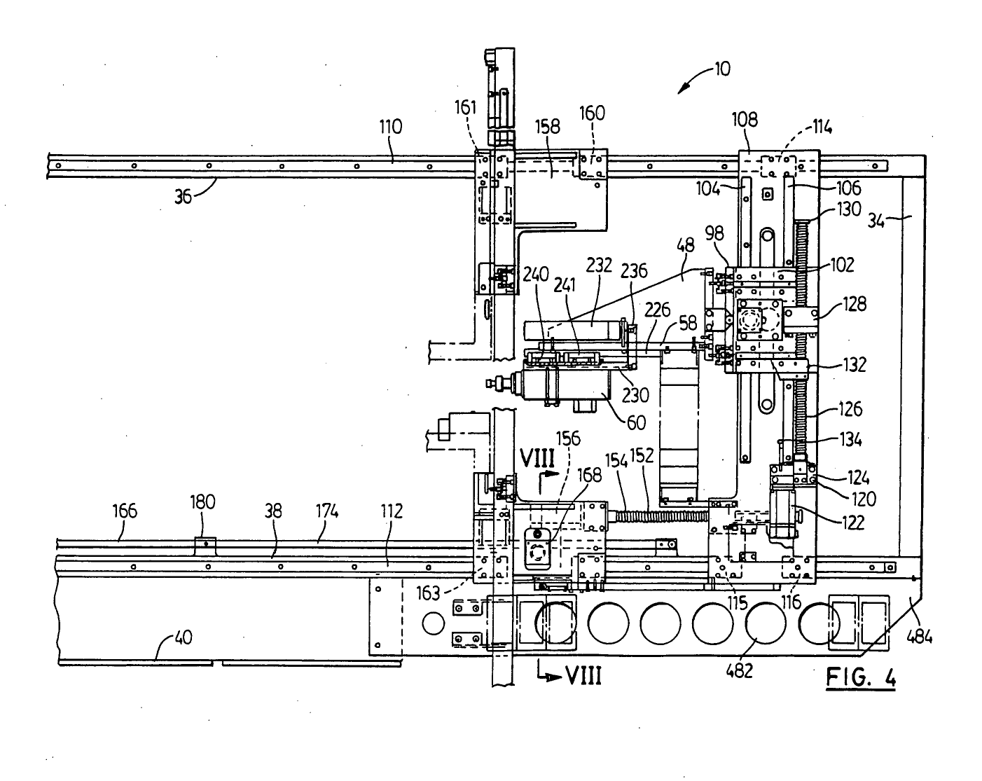

FIG. 4 is a top view of the right hand side of the apparatus of FIGS. 1 and 2;

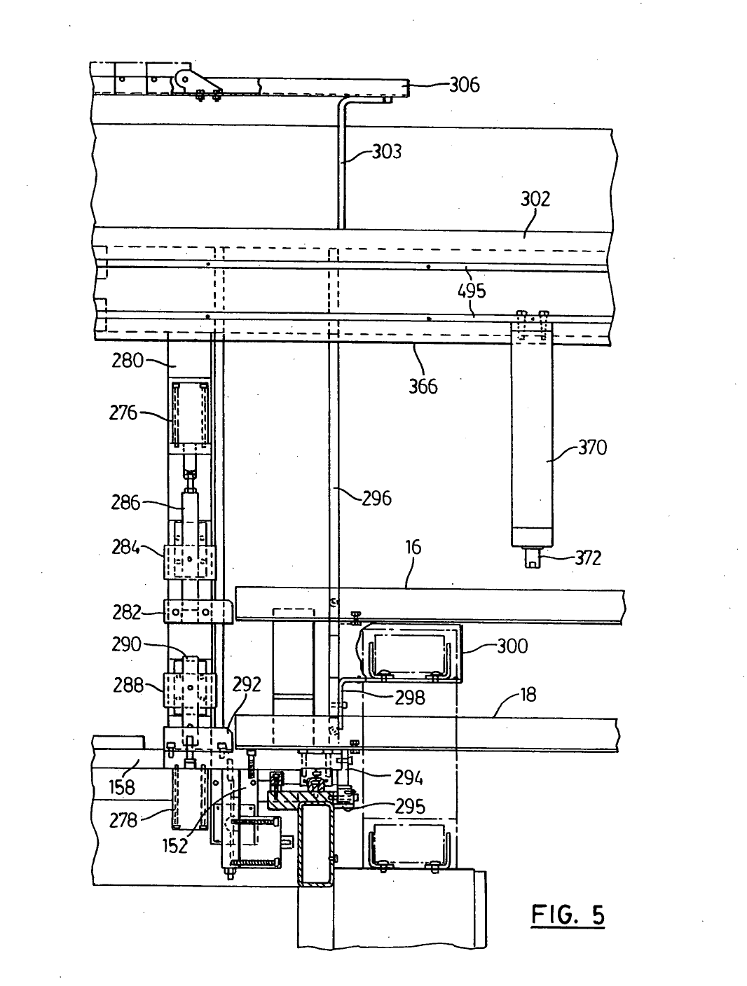

FIG. 5 is a detail view, partly in cross-section, taken along an upper portion of the line V-V of FIG. 2;

FIG. 6 is another detail, elevational view taken along the line V-V of FIG. 2, this view illustrating the manner in which the pairs of cleaning tools and machining tools are mounted to a vertical plate;

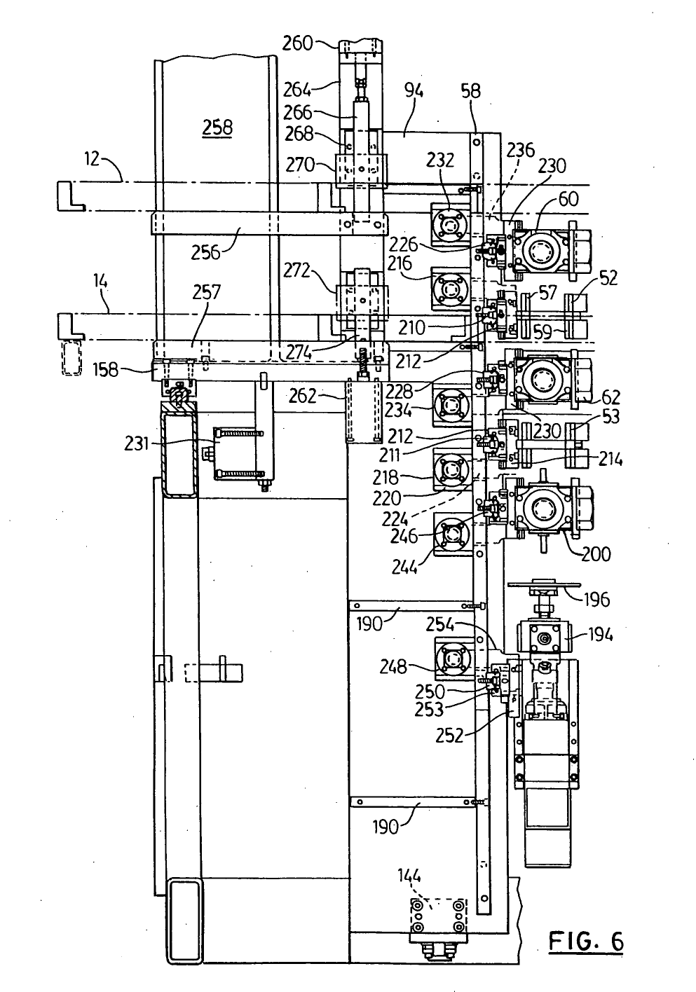

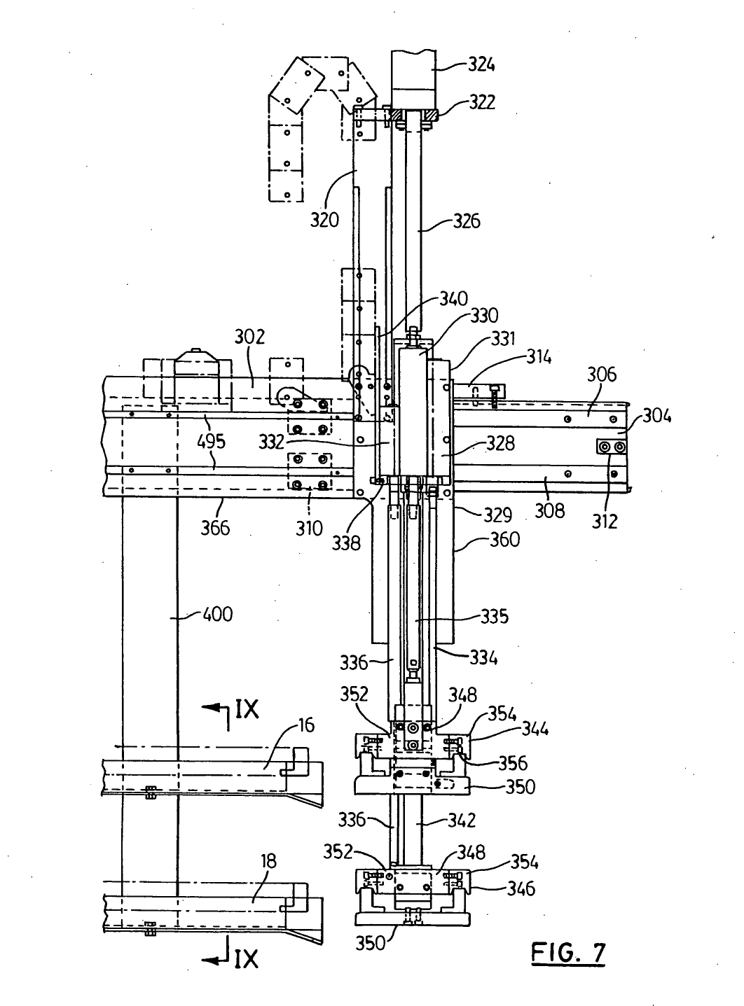

FIG. 7 is another detail elevational view taken along the upper portion of line V-V, this view illustrating a major portion of one of the arm assemblies used to move the two frameworks from the welder and horizontally along supporting rails;

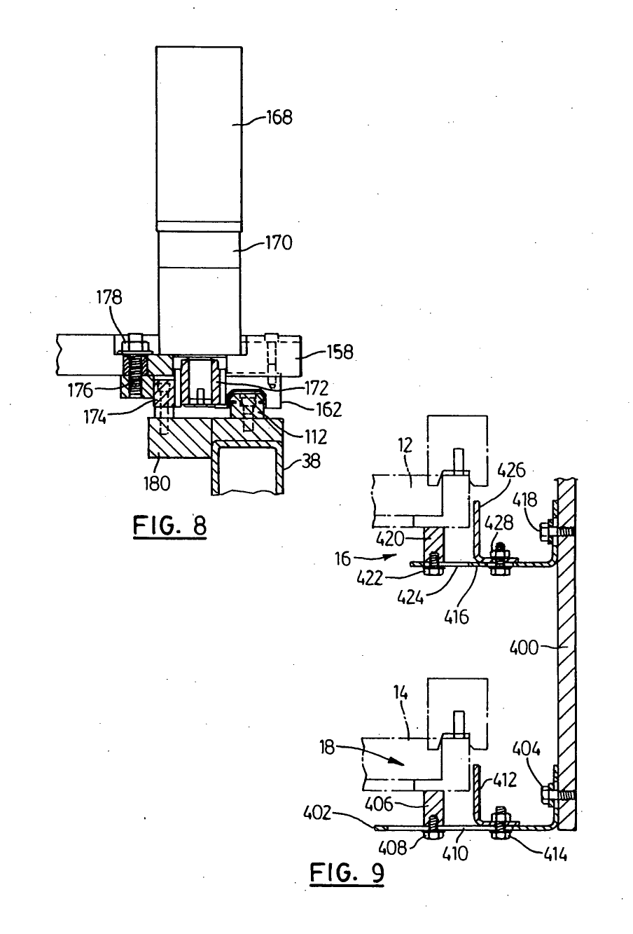

FIG. 8 is a detail elevational view in cross-section, this view being taken along the line VIII-VIII of FIG. 4;

FIG. 9 is a detail cross-sectional view of upper and lower support rails for the frameworks, this view being taken along the line IX-IX of FIG. 7;

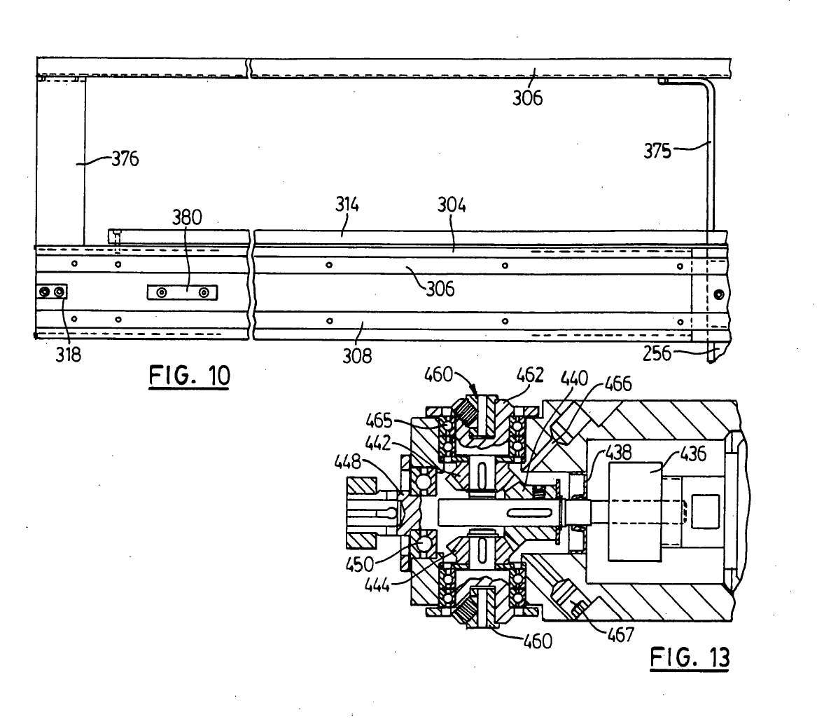

FIG. 10 is a detail elevational view taken along the upper most portion of the line V-V of FIG. 2, this view showing an end portion of the track for the movable arm assembly shown in FIG. 7, this end portion being at the end of the track opposite the end shown in FIG. 7;

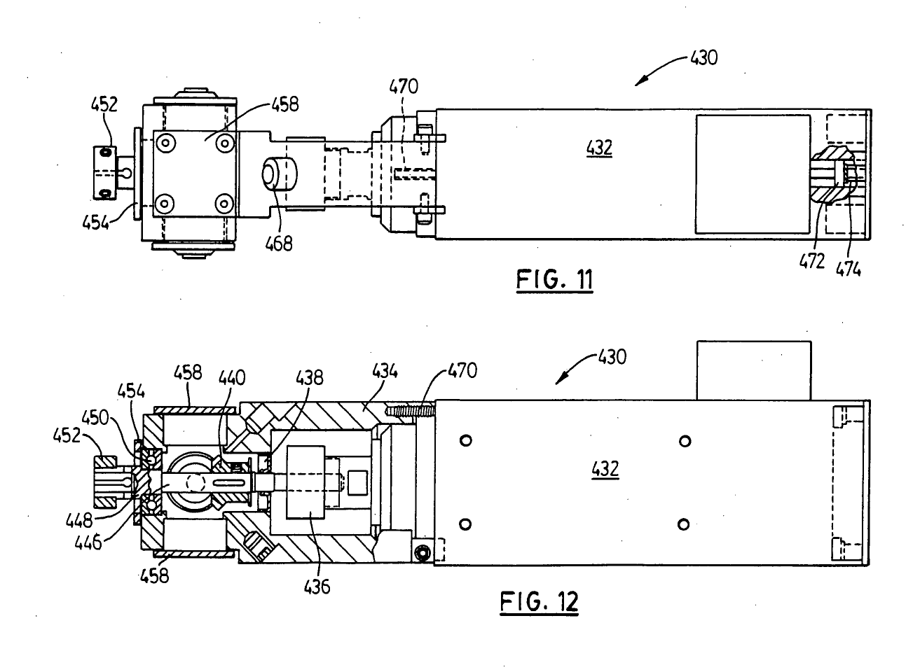

FIG. 11 is a side view of a drilling unit assembly that can be used in the apparatus of FIGS. 1 to 4 to carry out drilling steps;

FIG. 12 is a top view of the drilling unit assembly of FIG. 11 with the left side shown in axial cross-section taken along the centre axis of rotation; and

FIG. 13 is an axial cross-section of the head portion of the drilling unit assembly, this cross-section taken in a vertical plane.

### DETAILED DESCRIPTION OF PREFERRED EMBODIMENT

An apparatus 10 capable of both cleaning welds on rectangular plastic frames, such as window or sash frames, and carrying out additional processing or manufacturing steps on these frames is illustrated in FIGS. 1 to 4 with the left side of the apparatus shown in FIGS. 1 and 3 and the right side of this apparatus shown in FIGS. 2 and 4. Portions of the rectangular plastic frames are illustrated in chain-link lines in the drawings, including FIGS. 1 and 2 wherein an upper plastic frame is indicated at 12 and a lower plastic frame is indicated at 14. It will be appreciated that the preferred apparatus 10 is capable of carrying out either a weld cleaning operation or another processing step on both of the plastic frames 12 and 14 simultaneously, thereby increasing the overall efficiency and speed of the apparatus 10 as compared to previously known machines. It will also be appreciated that the dimensions of the plastic frames can vary and that the apparatus 10 is capable of accommodating plastic frames of different sizes, both in the widthwise direction of the frames and in their heights. It will also be understood that the frames 12 and 14 are moved horizontally through the apparatus 10 on pairs of support rails or rail sections described further hereinafter and these frames are arranged in horizontal, parallel planes as they move and as their welds are cleaned and other processing steps are carried out.

The preferred apparatus 10 includes first and second pairs of the aforementioned horizontally extending support rails, with the rails or rail sections of each pair being spaced horizontally apart a preselected distance corresponding to a dimension of a respective one of the rectangular frames 12, 14 that is arranged substantially horizontally and moved along that pair of rails during operation of the apparatus. The first or upper pair of support rails which can comprise two or more rail sections is indicated generally at 16 (see FIG. 5) while the second pair of support rails (which also can comprise two or more rail sections) are indicated generally at 18. These support rails will be described in more detail below with reference to FIG. 9.

The apparatus 10 also includes a left supporting frame arrangement indicated generally at 20 and a right supporting frame arrangement indicated generally at 22. On these supporting frame arrangements, the pairs of support rails 16, 18 are mounted with one rail or rail sections of each pair being mounted on the left supporting frame arrangement 20 and one rail or rail sections of each pair being mounted on the right supporting arrangement 22. It will be understood that these supporting frame arrangements are supported by and extend upwardly from a main frame 24 of the apparatus. The main frame is supported on legs 26 which can be arranged at the four corners of the main frame. The main frame includes horizontally extending, tubular frame members 28 and 30, these frame members being located near the bottom of the legs 26. Mounted on top of the legs are a left side connecting frame 32 and a right side connecting frame 34. These extend between and rigidly connect two long, transversely extending, tubular frames 36 and 38. Vertical side panels, including panels 40, 42 and 44 can be provided to cover the open sides of the main frame.

Continuing with a general description of the preferred apparatus 10, this apparatus also includes a left tool mounting mechanism 46 and a right tool mounting mechanism 48. Each of these mechanisms is cable of moving cleaning tools, such as new suitable knives, mounted thereon both horizontally and vertically as explained in more detail hereinafter. The left tool mechanism 46 is located adjacent the left supporting frame arrangement 20 and is preferably located substantially to the left of the supporting frame arrangement as shown in FIG. 1, that is on the outside thereof. The right tool mounting mechanism 48 is located adjacent the right supporting frame arrangement 22 and the rails mounted thereon and, as shown in FIG. 2, is preferably located substantially to the right of the supporting frame arrangement 22. These tool mounting mechanisms are described in more detail below, but it will be appreciated by those skilled in the art that although the preferred apparatus has two of these tool mounting mechanisms 46, 48, it is also possible to construct an apparatus which has only one of these tool mounting mechanisms, for example, either on the left or on the right side. In the latter case, and assuming that weld cleaning and machining are required on both sides of the plastic frames 12, 14, then it is possible to provide two of the apparatus 10 arranged one after the other, each with its own tool mounting mechanism in order to carry out all of the required weld cleaning and machining operations on the plastic frames.

Each of the tool mounting mechanisms 46, 48 has mounted thereon a pair of frame cleaning tools or devices 50 to 53. Each of these tools can comprise at least one weld cleaning knife. The illustrated frame cleaning device has three knives 55, 57 and 59 (as shown) of standard construction which are detachably mounted in a straight, elongate knife or blade holder 54. The three, spaced apart knives 55, 57 and 59 on each holder 54 each extend vertically and both upwardly and downwardly from their holder. Thus, these knives can be used to carry out cleaning steps on both the bottom and top sides of the plastic frames. One knife is used on the right side, another is used on the left, and the third is used in the centre of the framework. Each frame cleaning tool is movably mounted on its respective tool mounting mechanism 46, 48 for horizontal movement in a plane parallel to its respective tool mounting plate, the left hand tool mounting plate being indicated at 56 in FIG. 1 and the right hand plate being indicated at 58. The pair of frame cleaning tools, 50, 51 on the left side are spaced apart and arranged one above the other a distance corresponding to a selected vertical distance D between the two plastic frames 12, 14 arranged respectively on the first and second pairs of support rails when the apparatus is carrying out a weld cleaning operation on the two plastic frames. In one preferred embodiment, the distance D measured from the bottom of one plastic frame to the bottom of the other is 7.5 inches. Similarly, the pair of frame cleaning tools 52, 53 on the right side are also arranged one above the other the same distance corresponding to the selected vertical distance between the two plastic frames. As indicated above, each of the tool mounting mechanism 46, 48 and its respective pair of cleaning tools or cleaning devices are able to carry out weld cleaning operations on both of the plastic frames 12, 14 simultaneously by each pair of cleaning tools being moved at the same time and in a similar manner by their respective tool mounting mechanism.

Preferably there is also provided on the apparatus 10 at least one pair of machining tools on each of the tool mounting mechanisms 46, 48. The pair of machining tools on the left hand side of the apparatus 10 can be the same as or different from the pair of machining tools on the right hand side. In the illustrated apparatus 10, the pair of machining tools on each side are different. On the right hand side shown in FIG. 2, there is a pair of cutters 60, 62, each adapted to carry out a cutting operation on its respective plastic frame during use of the apparatus and it will be seen that these cutters are spaced apart the same distance D as the weld cleaning devices 52, 53. On the left hand side of the apparatus is a pair of drilling unit assemblies 64, 66, each having at least one drill bit collar 68 which can detachably hold a drill bit 70 in a spindle. The illustrated drill bit projects horizontally from the inner end of the drilling unit assembly. It is also possible for each of the drilling unit assemblies 64, 66 to have one or two drill bit holders arranged on respective sides of the assembly, as explained further hereinafter. It will be appreciated that a drilling unit assembly equipped in this manner is able to drill both horizontal and vertical holes and these can be drilled in the bottom, top or outer side surface of the respective plastic frame 12, 14. The distance between the horizontal center lines of the two drilling unit assemblies 64, 66 is the same distance D between the bottoms of the two plastic frames and between the two cleaning devices 50, 51.

Preferably the drilling unit assemblies 64, 66 have two or more drill bit holders as shown arranged on respective sides of the drilling unit assembly. In particular, the drilling unit assemblies of FIGS. 1 and 3 are each equipped with three drill bits. In addition to the bit 70, there are two horizontally extending bits 72, 74 projecting from opposite vertical sides of drill head 76. The construction of these drilling unit assemblies will be described in further detail with reference to FIGS. 11 to 13. As illustrated in FIG. 13, instead of drill bits projecting from the vertical sides of the drill head, it is also possible for the drill bits to be mounted on top and bottom sides of the drill head.

Reference will now be made to FIGS. 1 and 2 for the purpose of describing some of the components of the left and right tool mounting mechanisms and tools mounted thereon. It will be appreciated that each of the tool mounting mechanisms is constructed in substantially the same manner, except that the two mechanisms face in opposite directions. However, the tools mounted on each of these tool mounting mechanisms differ in the illustrated apparatus. On the left side, there is a circular saw assembly 80 that includes a circular saw blade 82 arranged to rotate about a vertical axis. The circular saw is rotated by an electric motor 84 supported by motor mounting plate 86. Protecting the top of the motor is a motor cover 88. Located at 90 are a collet and nut which detachably connect an arbor 92 for the circular saw blade. It will be seen that the circular saw is mounted below the lower cleaning tool 51 near the bottom of the mounting plate 56. It has been found that one circular saw on each side is sufficient because of the speed of operation of this type of saw. The saw blade 82 can be used to quickly carry out cutting operations on both plastic frames 12 and 14, if required. Also shown in FIG. 1 is a rail mounting plate 94 which extends vertically but in a plane perpendicular to that of the tool mounting plate 56. The plates 56 and 94 can be rigidly connected to one another by suitable screws as shown. Mounted on the outer surface of each plate 94 are two vertically extending rails 96 which permit vertical movement of the plates 94 and 56. Another vertically extending plate shown in cross-section in FIG. 1 is a carriage plate 98. On the inside surface of this plate are mounted four ball slides 100, two for each of the rails 96. Each carriage plate is attached by means of screws to a horizontal carriage mounting plate 102. The carriage mounting plate is movably mounted by means of two horizontal rails 104 and 106 on a main mounting plate 108 which is also arranged in a horizontal plane. The rails 104, 106 are attached by screws to the top of their respective plate 108.

Each of the plates 108 extends between and over the tops of the tubular frames 36, 38 and they are supported thereby. Each plate 108 is mounted on top of long rails 110, 112 that are detachably connected to the top of the frames 36, 38 by means of screws. In order to slidably mount each of the main mounting plates 108 on these rails, there are provided three ball slides located at 114 to 116. In order to move the carriage mounting plate 102 horizontally relative to the main mounting plate 108, there is provided a so-called cross screw drive assembly 120. This assembly includes a servo-motor 122 which drives a spur gear located in housing 124 which in turn drives another spur gear mounted on the end of a screw shaft 126. The screw shaft extends through ball nut housing 128. The ball nut housing is mounted by means of screws to the top of the plate 102. Rotation of the screw shaft by the servo-motor will cause the plate 102 and the components mounted thereon to move either towards the front or towards the rear of the apparatus 10. Also shown in FIGS. 3 and 4 is a washer 130 mounted on the end of the screw shaft which acts as a stop. Located near the ball nut housing is a cable track bracket 132 shown only in part. This bracket is connected to the top of the plate 102. An adjustable stop can also be provided at 134 by means of a suitable screw with an adjustment nut mounted thereon, the screw extending into the gear housing 124.

FIGS. 1 and 2 also illustrate the means for moving the tools and their respective mounting plates 56,58 vertically as required for the weld cleaning or machining operation. In particular, each tool mounting mechanism includes a vertical screw drive assembly 140. The screw drive assembly 140 can be constructed in a manner similar to the above described cross screw drive assembly 120. In particular, each of the two assemblies 140 includes a vertically extending screw shaft 142 that extends downwardly through the plate 102, through a slot 103 in the plate 108, and through a ball nut housing 144. The ball nut housing is attached by means of screws to the rail mounting plate 94. Mounted on a gear housing 146 is a servo-motor 148 which rotates a spur gear in the housing. This spur gear engages another spur gear mounted on the top end of the screw shaft 142. It will thus be appreciated that operation of the servo-motor 148 will cause the screw shaft 142 to rotate and this in turn will cause the plate 102 and the components and tools mounted thereon to move upwardly or downwardly as required. There can be mounted on the ball nut housing 144 a suitable adjustment screw 173 with an adjustment nut thereon to act as an adjustable stop.

Each of the tool mounting mechanisms 46, 48 preferably is capable of moving horizontally both in the left to right direction of the apparatus 10 and in a front to rear direction, the latter movement being powered by the aforementioned cross-screw drive assembly 120. Horizontal movement in the left to right direction of the apparatus is provided by further screw drive assembly 152 having a screw shaft 154. Each screw shaft assembly 152 is constructed in a substantially similar manner to the above described screw drive assemblies and accordingly a detailed description herein is deemed unnecessary. The assembly 152 includes a servo-motor 156 which is mounted on a gear housing that in turn is mounted to the bottom of the respective right or left main mounting platform 158. Each main mounting platform 158 extends in a horizontal plane and at least one of these platforms is mounted for horizontal movement on the rails 110 and 112 by means of four ball slides located at 160 to 163. It will be understood that each of the main mounting platforms is part of the left or right supporting frame arrangement on which the pairs of support rails are mounted. The horizontal distance between the two main mounting platforms 158 is adjustable in order to accommodate plastic frameworks of different sizes. Once the distance between these main mounting platforms has been set however, it is then possible to move each of the mounting plates 108 relative to its respective platform 158 in order to carry out required weld cleaning and/or machining operations. However, it is only necessary for one of the platforms 158 to be adjustable in the left to right direction. In the illustrated apparatus, the left hand platform 158 shown in FIG. 3 can be fixed in its position while the right hand platform 158 shown in FIG. 4 is adjustable horizontally by means of a rack mechanism indicated generally at 166. The rack of this mechanism is fixedly attached to the inside wall of the tubular frame 38.

The manner in which the rack is engaged can be seen clearly in FIG. 8. Mounted on top of the right hand platform 158 is a servo-motor 168. The servo-motor is directly mounted on a planetary gear head 170 which in a preferred embodiment has a ratio of 10:1. The gear head drives a spur gear 172 which can be located in an opening formed in the platform. The spur gear engages one side of the horizontal rack 174. Located opposite the spur gear is a slider assembly 176 which maintains the rack in engagement with the gear. The slider assembly is connected to the bottom of the platform by means of a nut 178 and washer. Operation of the servo-motor 168 will cause the platform 158 to move along the rack 174 and along the rail 112. Also shown is a series of supporting lugs 180 on which the rack 174 is mounted by means of screws.

Additional minor features shown in FIGS. 1 and 2 include an electrical cable track 182 and supporting bracket 183 mounted on top of the apparatus. There is a cable track support 184 mounted below the top of the bracket and supported by another support bracket 186 that is attached to the top of the supporting frame arrangement 20 or 22. Shown in chain-link lines on the outer side of each supporting frame arrangement is an optional safety guard 188 which provides protection against the moving components of the machine. To strengthen the connection between each of the plates 56, 58 and its respective rail mounting plate 94, there can be provided a series of vertically spaced gussets 190. Located at the top of each rail mounting plate 94 is a stop 192 defining the upper limit of movement of the carriage plate. There is also a stop 191 at each end of each long rail 110, 112.

Shown in FIG. 2 is an additional machining or processing tool in the form of a combined drill and circular saw assembly 194 on top of which is a circular saw blade 196 that rotates about a vertical axis. The assembly 194 can be fitted with at least one drill bit 198, the illustrated bit projecting horizontally inwardly. Located above the assembly 194 is a drilling unit assembly 200 which can be constructed in a manner the same as or similar to the drilling unit assemblies 64, 66 located on the left side of the apparatus shown in FIG. 1. Again, it will be understood that the distance between a drill bit 202 mounted in the end of the assembly 200 and the drill bit 198 is the same distance D that separates the plastic frames 12 and 14. The illustrated drilling unit assembly 200 has two drill bit holders 204 arranged on the top and bottom of the drilling unit assembly. As illustrated, in addition to the drill bit 202, two drill bits 206 extend from the top and bottom sides of the assembly 200.

The manner in which the cleaning tools and additional machining tools are movably mounted on their respective mounting plates 56, 58 will now be described with particular references to FIGS. 1 to 4 and FIG. 6. As can be seen in FIG. 6, each of the weld cleaning tools or devices 52, 53 is mounted on its own horizontal rail 210 and 211 for sliding horizontal movement. Mounted on each of these rails by means of a ball slide 212 is a mounting bar 214 on which the knife holder and attached knife or blade are mounted. Each of the cleaning tools 52, 53 is movable by means of an air cylinder actuator 216, 218. These actuators each include an air cylinder fixedly mounted on a side of the vertical tool mounting plate 56 or 58 and, as shown, these air cylinders 220 are located on the side of the plate opposite the tool. A movable actuator rod extends from the an outer end of the air cylinder 220 and a connecting bracket 224 indicated in dash lines in FIG. 6 joins the actuator rod to its respective cleaning tool by projecting through a slot formed in the plate 58 or 56.

Similarly, with reference to FIG. 6, the two cutter units 60, 62 are mounted for horizontal movement on respective horizontal rails 226, 228. These cutter units are each mounted on a plate 230 which is attached by screws to two ball slides 240, 241 mounted on the rail (see FIG. 4). Each of these tools or cutters is movable by means of its own air cylinder mechanism 232 and 234. Again, each of these air cylinder mechanisms includes an air cylinder fixedly mounted on the plate 58 on the side opposite the tool or cutter. The movable actuator rod extending from the air cylinder is joined to a connecting bracket 236. A horizontal slot 244 through which the connecting bracket 236 extends can be seen in FIG. 2 and similar horizontal slots are formed for the other connecting brackets that they join their respective tools to their air cylinders actuators.

Also visible in FIG. 6 is an air cylinder actuator 244 which is used to move the drilling unit assembly 200 horizontally. This assembly is mounted on rail 246. Further down on the plate 58 is an additional air cylinder actuator 248 which is used to move the combination drill and circular saw assembly 194 horizontally. The assembly 194 is mounted for horizontal movement on a rail 250 by means of mounting plate 252. Again, two ball slides 253 can be mounted on the plate 252 for movement along the rail. At the outer end of the plate 252 is a connecting bracket 254 which extends through horizontal slot 255 to the air cylinder actuator 248.

Additional features visible in FIG. 6 include a rear top support 256 and a rear bottom support 257, each of which can be in the form of a rail section that can be rigidly attached to support post 258 which is an I-beam. Also visible and located near the front end of the supports 256, 257 are two air cylinders 260, 262. The upper cylinder 260 is mounted on vertical support frame 264 along which extends vertical rail 266. The downwardly extending actuator rod of the cylinder 260 is attached to a mounting block 268 on which a ball slide and a vertically movable clamp 270 are mounted. The clamp 270 can be used to selectively clamp an upper plastic frame 12 between itself and the top support or rail section 256. Similarly, the air cylinder 262 operates a bottom clamp 272 which is vertically movable along rail 274 by means of a ball slide. The clamp 272 can be used to hold lower plastic frame 14 against the bottom support or rail section 257. Note that the top end of the air cylinder 262 is mounted on the bottom of main mounting platform 158 with the actuator rod extending through a hole in the platform. Also shown in FIG. 6 is a pneumatic cylinder brake 231 having a carbide gripping pad at the outer end of its actuator rod. This brake is attached to the bottom of the platform 158 and is engaged when the tools and cleaning devices are being used to maintain rigidity and prevent vibration.

Turning now to FIG. 5, there is illustrated therein additional clamping devices for the apparatus, these being mounted a short distance to the right of the cleaning tool 52 and the cutter 60 as shown in FIG. 6. There is shown an upper air cylinder actuator 276 and a lower air cylinder actuator 278. The upper air cylinder is mounted on vertical frame 280 which again is part of the right supporting frame arrangement 22. Mounted below the cylinder 276 is a front top support 282 which is located adjacent an end of a section of support rail 16 and in line therewith. The cylinder actuator 276 operates a clamp 284 which can press an upper plastic frame against the support 282. The clamp is movable vertically by means of a ball slide that runs along a rail 286. Similarly, the cylinder actuator 278 operates a clamp 288 that runs along a rail 290. The clamp 288 can be used to hold the bottom plastic frame against the top of a front bottom support 292. The support 292 is adjacent one end of a section of support rail 18. The bottom support 292 is mounted by screws to the top of main mounting platform 158, The air cylinder 278 is mounted to the bottom of the platform which has a hole through which the actuator rod extends. It will thus be seen that both the top and bottom plastic frames 12 and 14 can be clamped securely during a cleaning or machining operation.

Additional features shown in FIG. 5 include the horizontal screw drive assembly 152 which is mounted below the platform. On the edge of the platform 158 there is a stop 294. Another stop is provided at 295. Together these two stops limit the extent of movement of the right platform 158 along its rails. Mounted to the side of a vertical I-beam 296 is a cable track bracket 298 and extending over top of the cable track is a cover 300. Shown near the top of FIG. 5 is a horizontally extending central section of a slidable gripper arm assembly 302, explained in more detail hereinafter. This assembly is slidable along rails mounted on the inside surface of a horizontally extending track (which is hidden in FIG. 5). Extending upwardly from this track is a support bracket 303 which supports an elongate channel support 306 for a cable track. Extending along the side of each gripper arm assembly 302 are two reinforcing ribs 495 which are parallel and horizontal.

Reference will now be made to FIG. 7 which illustrates the portion of the gripper arm assembly 302 to the right of the central portion shown in FIG. 5. Also visible in FIG. 7 is an end portion of the tubular track 304 on which the gripper arm assembly moves horizontally. This end of the track is placed next to the welder that forms the plastic frameworks. On the inner wall of the track are two parallel, horizontal rails 306 and 308 and it will be appreciated that ball slides 310 attached to the gripper arm assembly 302 slidably mount the gripper arm assembly on these two rails. A suitable stop 312 is provided at the end of the track to limit horizontal movement of the arm assembly. Mounted on top of the track is a rack 314 having a number of teeth extending along its length on one side. A servo-motor 316 shown in FIG. 2 drives a spur gear 318 which engages the teeth of the rack in order to move the gripper arm assembly along the rails. Servo-motor 316 can be mounted at the end of the gripper arm assembly opposite the end 329 shown in FIG. 7. It should be appreciated that the gripper arm assembly 302 is constructed somewhat similar to the gripper arm assemblies described and illustrated in applicant's co-pending U.S. patent application Ser. No. 10/716,344 filed Nov. 18, 2003 and the disclosure and drawings of this co-pending application are incorporated herein by reference.

Extending upwardly from the top of the gripper arm assembly is a vertical post 320, at the top of which is a horizontal support plate 322. Mounted on top of this plate is a pneumatic cylinder 324. Extending downwardly through a hole in the plate 322 is an actuator rod 326 which can be moved upwardly or downwardly in the cylinder. Connected to the bottom end of the rod 326 and movable thereby is a gripping arm unit 328. This unit includes three linear actuators, 330, 331, and 332 of different lengths. These actuators have downwardly extending actuator rods 334, 335 and 336. The bottoms of the air cylinders are mounted on support plate 338. Cable track bracket 340 can be attached to an edge of the plate 338. Each gripper arm assembly 302 includes a downwardly extending, elongate gripper support member 342 on which upper and lower gripper units 344 and 346 are mounted. Each gripper unit includes an upper gripper assembly 348 and a horizontal gripper plate 350. The upper plate 350 is slidably mounted to the side of the support member 342 while the lower gripper plate 350 is attached by screws to the bottom end of the support member 342. Each upper gripper assembly 348 includes a central block 352 and two side extensions 354 attached by screws to the central block. A recess 356 is formed in the bottom of each side extension and is sized to receive an upwardly projecting edge of the plastic framework as shown. It will be appreciated that each upper gripper assembly 348 is able to move upwardly or downwardly relative to its gripper plate 350 for the purpose of gripping a section of the framework. The uppermost gripper assembly 348 is moved upwardly or downwardly by means of the rod 334 while the lower gripper assembly 348 is moved upwardly or downwardly by means of the rod 336. Both of the gripper units 344, 346 and their actuators are movable vertically a substantial distance by means of the linear actuator rod 326. In particular, the support member 342 and the plate 338 are mounted for vertical movement on the downwardly projecting, vertical plate 360. Attached to the plate 360 are ball slides 362 visible in FIGS. 1 and 2. Thus, the gripper units 344, 346 can be moved upwardly above the plastic frameworks so that they can be moved past these frameworks as and when required, for example, to move from the left side of the framework to the right side. A vertical rail 363 is attached to the outer surface of the support member 342 and runs along the ball slides 362. The central actuator rod 335 is used to separate the upper and lower gripper units 344 and 346 after they pull the two plastic frameworks from the welder where they are formed a short distance apart, ie. only 3-4 inches. The actuator rod 335 can be used to increase the distance between the plastic frames so that they can be machined and cleaned. In one preferred embodiment, the vertical space between the frameworks is increased to 7.5 inches, which is equivalent to the distance between the tool pairs in this embodiment. The actuator rod 335 is connected to the upper gripper plate 350 and is able to move it towards or away from the lower gripper plate 350 along the support members 342. A horizontally extending side plate 366 is connected to the vertical plate 360 and this plate connects the plate 360 of the gripper arm assembly 302 to the servo-motor 316.

Mounted approximately midway along the length of each gripper arm assembly 302 is a central, downwardly extending air cylinder actuator 370 which is mounted at its top end to the horizontally extending plate 366. The pneumatic cylinder of the actuator is arranged on a vertical axis and has an actuator rod 372 that can be projected from its bottom end. The rod 372 can be extended a sufficient distance downwardly to engage inside surfaces of the upper and lower plastic frameworks. In this position, the actuators of the two arms 370 can be used to push the two plastic frameworks along the rear sections of their respective support rails in order to remove the plastic frameworks from the apparatus 10. They can then be deposited, for example, on a suitable unloading conveyor assembly arranged adjacent the rear side of the apparatus 10. When the actuator 370 are not required for pushing the frameworks, the actuator rods 372 can be raised to the position shown in FIG. 5 so that the actuator 370 can be moved horizontally past the plastic frameworks.

FIG. 10 illustrates a rear end section of the track 304 for one of the gripper arm assemblies. The section shown is to the left of the support post 258 shown in FIG. 6, a corner of which is shown on the right side of FIG. 10. Extending upwardly from the track is a cable support bracket 375 which connects to support channel 306 for the cable track. Another support bracket 376 extends upwardly from the end of the track and is connected to channel 306 as well. A stop 378 is mounted at the end of the track on its inner wall and acts to limit the rearward movement of the gripper arm assembly. Mounted forwardly of this stop on the side of the track is a fixed actuator 380 which is part of a proximity switch used to sense the location of the gripper arm assembly.

Turning to FIG. 9, this cross-sectional elevation illustrates a preferred arrangement of the rails or sections thereof for supporting plastic frameworks 12 and 14. The rails can be mounted on vertical mounting bar 400, the side of which can be seen in FIG. 7. This bar extends downwardly from and is attached to the horizontal track 304. Connected to the bottom of the bar 400 is guide support 402 in the form of an angle member that is attached by means of screw and washer combinations 404. Adjustably mounted on the support 402 is an elongate support bar 406 which is part of the bottom support rail 18. The transverse position of the bar 406 is adjustable by means of attachment screws 408 which extend through elongate slots 410 formed in the guide support. The support rail further includes a side guide member 412 which also is an angle member and is attached to the support 402 by nut and bolt combinations 414. The bolts also extend through the slots 410 and therefore their position can be adjusted as well. A somewhat similar support rail arrangement is provided for the upper support rail 16. This rail assembly also includes a top guide support 416 in the form of an angle member connected to the bar 400 by screw 418. Adjustably connected to the outer end of the support 416 is an elongate support bar 420 that supports the plastic frame 12 from the bottom. The bar 420 is attached by screws 422 which extend through elongate slots 424. Thus, the bar 420 can be moved transversely a short distance, if required. The upper support rail also includes side guide member 426 which is attached by bolt and nut combinations 428 to the guide support 416. It will be understood that the guide members 412, 426 engage vertical sides of the plastic frames and thus act to guide the direction of horizontal movement.

FIGS. 11 to 13 illustrate a preferred construction of a drilling unit assembly that can be used as one or more of the machining tools of the apparatus 10. This drilling unit assembly 430 is shown with an electric motor 432 which in one embodiment is a one horse power motor sold by Teknomotor and capable of rotating at 12,000 RPM. Attached to this motor is a housing 434 in which is mounted a collett and ring nut 436. A drive shaft extends outwardly from the collett and ring nut through a seal 438 and mounted on the shaft is a spiral bevel gear 440. As shown in the vertical cross-section of FIG. 13, the gear 440 can turn upper and lower bevel gears 442 and 444 mounted on stub shafts. The central horizontal shaft 446 extends to a spindle 448 mounted in ball bearings 450. Mounted on the spindle is a collar 452 which can be secured by a set screw (not shown). It will be understood that a drill bit (not shown) can be mounted in the spindle in a known manner using the collar. A cover 454 extends over the outside of the bearings. The sides of the head of the assembly where there are no projecting drill bits can have openings therein covered by plates 458 held in place by suitable screws.

Also shown in FIGS. 11 and 12 are the means for attaching the drilling unit assembly to its support. This includes two long studs 470 mounted on opposite sides of the motor 432. Each stud extends through a washer 472, a spring washer, and a nut 474 located at the right end of the motor as seen in FIGS. 11 and 12.

With reference to FIG. 13 which shows an assembly for vertical drill bits, there are upper and lower bushings 460 in which the drill bits can be held by means of set screws. These bushings are mounted in a spindle assembly 462 which includes a short stub shaft on which the bevel gears 442, 444 are mounted. The spindle assemblies are rotatably mounted by means of ball bearing 465. Suitable lubrication in the form of a mixture of compressed air and oil for the gears can be provided through inlet passageway 466. The passageway 467 is an outlet for the lubricating mixture.

The perforated plate 480 shown at the bottom of FIG. 3 is part of the electrical box for the apparatus 10. The series of holes 482 in the plate 484 are simply provided to permit plastic chips from the cleaning and machining operations to fall through them to the floor.

The movement of the individual tools, including the cleaning and drilling tools, is controlled by programmable logic controllers (PLCs) in a manner known per se in the machine tool industry and, in particular, in the window frame manufacturing industry. A programmable industrial computer, which can also be of standard construction, provides control signals to the PLCs. This computer can be provided with a touch screen for ease of operation. Again, the use of computers of this type to control a window frame making machine is known in the window making industry.

It will be readily apparent to those skilled in the art of window making machinery that various modifications and changes can be made to the described apparatus for cleaning and processing frameworks without departing from the spirit and scope of this invention. Accordingly, all such modifications and changes as fall within the scope of the appended claims are intended to be included in this invention.

1. An apparatus for cleaning welds on rectangular plastic frames, such as window or sash frames, each formed from four frame sections comprising top and bottom frame sections and two parallel side frame sections, said apparatus comprising:
first and second pairs of horizontally extending support rails with the rails of each pair being spaced horizontally apart a preselected distance corresponding to a dimension of a respective one of said rectangular frames that is arranged substantially horizontally and moved along that pair of rails during operation of the apparatus, said first pair of support rails being spaced above said second pair of support rails;
left and right supporting frame arrangements on which said pairs of support rails are mounted, one rail from each pair being mounted on the left supporting frame arrangement and one rail from each pair being mounted on the right supporting frame arrangement;
left and right tool mounting mechanisms each capable of moving cleaning tools mounted thereon both horizontally and vertically, said left tool mounting mechanism being located adjacent said left supporting frame arrangement and the rails mounted thereon and said right tool mounting mechanism being located adjacent said right supporting frame arrangement and the rails mounted thereon; and
a pair of frame cleaning tools movably mounted on each of said tool mounting mechanisms with the frame cleaning tools of each pair being spaced apart and arranged one above the other a distance corresponding to a selected vertical distance between two plastic frames arranged respectively on said first and second pairs of support rails when said apparatus is carrying out a weld cleaning operation on said two plastic frames,
wherein each of said tool mounting mechanisms and its respective pair of cleaning tools is able to carry out a weld cleaning operation on both of said plastic frames simultaneously by each pair of cleaning tools being moved at the same time and in a similar manner by their respective tool mounting mechanism.

2. An apparatus for cleaning welds according to claim 1 including an additional pair of machining tools movably mounted on each of said tool mounting mechanisms, each additional pair of tools being spaced apart and arranged one above the other said distance corresponding to the selected distance between the two plastic frames.

3. An apparatus for cleaning welds according to claim 2 wherein said additional pair of machining tools is a pair of cutters each adapted to carry out a cutting operation on its respective plastic frame during use of said apparatus and said pair of frame cleaning tools is a pair of knife tools.

4. An apparatus for cleaning welds according to claim 2 including two rotatable circular saws and two motors for rotating said saws, each circular saw and its respective motor being movably mounted on a respective one of said tool mounting mechanisms and being adapted to carry out a cutting operation on at least one of said two plastic frames.

5. An apparatus for cleaning welds according to claim 1 wherein each of said tool mounting mechanisms is capable of moving horizontally both ways in the left to right direction of the apparatus and in a front to rear direction, each tool mounting mechanism including a first horizontal screw drive assembly, a main mounting plate operatively connected to said screw drive assembly for movement selectively in the left to right direction and in the opposite direction, a second screw drive assembly mounted on said main mounting plate, and a carriage mounting plate operatively connected to said second screw drive assembly for movement selectively in said front to rear direction and in a reverse horizontal direction.

6. An apparatus for cleaning welds according to claim 2 including left and right frame gripping assemblies and horizontally extending support tracks on which said gripping assemblies are respectively mounted for horizontal, two way movement in the front to rear direction of the apparatus, wherein said gripping assemblies are capable of moving said plastic frames horizontally along their respective pairs of support rails and gripping said plastic frames during a cleaning or machining operation of the apparatus.

7. An apparatus for cleaning welds according to claim 1 including at least one drilling unit assembly mounted on one of said tool mounting mechanisms and having two or more drill bit holders arranged on respective sides of the at least one drilling unit assembly.

8. An apparatus for cleaning welds according to claim 2 including a drilling unit assembly and a combined drill and circular saw assembly both movably mounted on one of said tool mounting mechanisms, at least said drilling unit assembly having two or more drill bit holders arranged on respective sides of the drilling unit assembly, wherein said drilling unit assembly and said combined drill and circular saw assembly are spaced apart and arranged one above the other so that a selected vertical distance between two drill bits mounted respectively in corresponding sides of said drilling unit assembly and the combined drill and circular saw assembly corresponds to said selected distance between the two plastic frames.

9. An apparatus for cleaning welds according to claim 2 wherein each tool mounting mechanism includes a vertical tool mounting plate which is vertically movable on at least one rail and both the respective pair of frame cleaning tools and the respective pair of machining tools are mounted for horizontal movement on said tool mounting plate.

10. An apparatus for cleaning welds according to claim. 9 wherein each tool mounting mechanism includes air cylinder mechanisms for moving said frame cleaning tools and said machining tools horizontally on said tool mounting plate, each air cylinder mechanism including an air cylinder fixedly mounted on a side of said vertical tool mounting plate, a movable actuator rod extending from one end of the air cylinder, and a connecting bracket joining said actuator rod to its respective cleaning tool or machining tool.

11. An apparatus for cleaning welds on and machining rectangular plastic frames, such as window sash frames, said apparatus comprising:
a supporting arrangement capable of rigidly supporting two of said plastic frames in a spaced-apart manner and holding one plastic frame above the other in a manner that permits cleaning or machining operations to be carried out on the plastic frames simultaneously;
at least one pair of spaced-apart cleaning tools;
at least one pair of spaced-apart machining tools;
at least one tool mounting mechanism, the or each tool mounting mechanism having one pair of said cleaning tools and at least one pair of said machining tools mounted thereon and capable of moving its respective cleaning tools and machining tools both horizontally and vertically, the at least one tool mounting mechanism being located adjacent said supporting arrangement, the cleaning tools of said one pair being mounted one above the other and the machining tools of the one of each pair being mounted one above the other,
wherein each of said one pair of cleaning tools and said at least one pair of machining tools is capable of carrying out a weld cleaning operation or a machining operation on both of said two plastic frames simultaneously by the appropriate pair of tools being moved at the same time and in a similar manner.

12. An apparatus according to claim 11 wherein there are two of said at least one tool mounting mechanism including a left tool mounting mechanism located adjacent a left side of said supporting arrangement and a right tool mounting mechanism located adjacent a right side of said supporting arrangement.

13. An apparatus according to claim 12 wherein said at least one pair of machining tools includes one pair of rotatable cutters and two motors for respectively rotating said cutters, each cutter being operatively connected to its respective motor and adapted to carry out a cutting operation on a respective one of said two plastic frames during use of said apparatus.

14. An apparatus according to claim 12 including a rotatable circular saw and a motor for rotating said saw movably mounted on each of said tool mounting mechanisms, wherein each circular saw is adapted to carry out cutting operations on both of said two plastic frames.

15. An apparatus according to claim 11 wherein the or each tool mounting mechanism is capable of moving both ways in two horizontal directions including a transverse direction and a rear to front direction relative to the apparatus, the latter direction being perpendicular to said transverse direction, the or each tool mounting mechanism including a first horizontal screw drive assembly, a main mounting plate operatively connected to said screw drive assembly for movement selectively either way in said transverse direction, a second screw drive assembly mounted on said main mounting plate, and a carriage mounting plate operatively connected to said second screw drive assembly for movement selectively in said rear to front direction and in the reverse direction.

16. An apparatus according to claim 12 including left and right frame gripping assemblies and horizontally extending support tracks on which said gripping assemblies are respectively mounted for horizontal, two way movement in a direction parallel to a rear to front direction of the apparatus, wherein said gripping assemblies are adapted to move simultaneously said two plastic frames horizontally along said supporting arrangement which includes horizontally extending, elongate upper and lower frame edge supporting surfaces.

17. An apparatus according to claim 11 including at least one drilling unit assembly mounted on one of said at least one tool mounting mechanism and having two or more drill bit holders arranged on respective sides of said at least one drilling unit assembly.

18. An apparatus according to claim 12 including a drilling unit assembly and a combined drill and circular saw assembly both movably mounted on one of said tool mounting mechanisms, at least said drilling unit assembly having two or more drill bit holders arranged on respective sides of the drilling unit assembly, wherein said drilling unit assembly and said combined drill and circular saw assembly are spaced apart and arranged one above the other so that a selected vertical distance between two drill bits mounted respectively in corresponding sides of said drilling unit assembly and the combined drill and circular saw assembly corresponds to a selected vertical distance between said two plastic frames when they are held in said supporting arrangement for a machining operation.

19. An apparatus according to claim 11 wherein the or each tool mounting mechanism includes a vertical tool mounting plate which is vertically movable on at least one rail and both said one pair of cleaning tools and said at least one pair of machining tools are mounted for horizontal movement on said tool mounting plate.

20. An apparatus according to claim 19 wherein the or each tool mounting mechanism includes pneumatic actuators for moving said one pair of frame cleaning tools and said at least one pair of machining tools horizontally on said tool mounting plate, each pneumatic actuator including an actuator body fixedly mounted on a side of said vertical tool mounting plate.

21. An apparatus for cleaning welds on and processing rectangular plastic frames, such as window sashes, said apparatus comprising:
a supporting arrangement capable of rigidly supporting two of said plastic frames in a spaced apart manner and holding one of said plastic frames above the other in a manner that permits weld cleaning or machining operations to be carried out on the two plastic frames simultaneously;
at least one pair of spaced-apart knife holders each adapted to rigidly support at least one weld cleaning knife or blade;
at least one pair of spaced-apart machining tools;
at least one tool mounting mechanism, the or each tool mounting mechanism having one pair of said knife holders and at least one pair of said machining tools mounted thereon and capable of moving its respective knife holders and machining tools both horizontally and vertically, said at least one tool mounting mechanism being adapted for mounting adjacent said supporting arrangement, the knife holders of said one pair being mounted one above the other and the machining tools of the one or each pair being mounted one above the other and at different heights than the knife holders,
wherein, when suitable knives or blades are mounted in said knife holders, said one pair of knife holders and their respective knives or blades and said at least one pair of machining tools are capable of carrying out a weld cleaning operation or a machining operation on both of said plastic frames simultaneously by the appropriate pair of tools being moved at the same time and in a similar manner.

22. An apparatus according to claim 21 wherein there are two of said at least one tool mounting mechanism including a left tool mounting mechanism located adjacent a left side of said supporting arrangement and a right tool mounting mechanism located adjacent a right side of said supporting arrangement.

23. An apparatus according to claim 21 wherein said at least one pair of machining tools includes one pair of rotatable cutters and two motors for respectively rotating said cutters, each cutter being operatively connected to its respective motor and adapted to carry out a cutting operation on a respective one of said two plastic frames during use of said apparatus.

24. An apparatus according to claim 22 wherein each tool mounting mechanism is capable of moving both ways in two horizontal directions including a transverse direction relative to the apparatus and a second direction perpendicular to said transverse direction, each tool mounting mechanism including a first horizontal screw drive assembly, a main mounting plate operatively connected to said screw drive assembly for movement selectively either way in said transverse direction, a second screw drive assembly mounted on said main mounting plate, and a carriage mounting plate operatively connected to said second screw drive assembly for movement selectively in said second direction.

25. An apparatus according to claim 22 wherein one of said tool mounting mechanisms has first and second pairs of said spaced-apart machining tools movably mounted thereon, said first pair comprising a pair of rotatable cutters and two motors for respectively rotating said cutters about respective horizontal axes, each cutter being operatively connected to its respective motor, and said second pair comprising a pair of drilling unit assemblies each having two or more drill bit holders arranged on respective sides of the drilling unit assembly and a motor for rotating one or more of said drill bit holders with a respective drill bit mounted therein.

26. An apparatus according to claim 22 wherein each tool mounting mechanism includes a vertical tool mounting plate support which is vertically movable on rails and both said one pair of knife holders and said at least one pair of machining tools are mounted for horizontal movement on said tool mounting plate support.

27. An apparatus according to claim 22 wherein said supporting arrangement includes first and second pairs of horizontally extending support rails with the rails of each pair being parallel and spaced horizontally apart a preselected adjustable distance corresponding to a dimension of a respective one of said two plastic frames, said plastic frames being arranged substantially horizontally on said support rails during use of said apparatus.

28. An apparatus according to claim 27 wherein said supporting arrangement further comprises movable clamps arranged along or next to each of said pairs of support rails and adapted to hold said plastic frames rigidly and temporarily in position for at least one of the weld cleaning and machining operations.

29. An apparatus according to claim 22 wherein each tool mounting mechanism also has a rotatable circular saw and a motor for rotating said saw movably mounted thereon, said saw being rotatable about a vertical axis of rotation defined by an output shaft of said motor.

30. An apparatus according to claim 25 wherein one of said drilling unit assemblies includes a rotatable circular saw mounted for selective rotation by the motor of said one drilling unit assembly, said circular saw being rotatable about a vertical axis of rotation defined by an output shaft of said motor of said one drilling unit assembly.
